(19) United States
(12) Patent Application Publication
(10) Pub. No.: US 2007/0287002 A1
(43) Pub. Date: Dec. 13, 2007

(54) Scented exercise mat

(76) Inventor: Richard Cabados, Carlsbad, CA (US)

Correspondence Address: ERIC HANSCOM, 7395 PORTAGE WAY, CARLSBAD, CA, 92011, US

(21) Appl. No.: 11/447,813

(22) Filed: Jun. 7, 2006

(51) Int. Cl. B32B 27/00

(52) U.S. Cl. 428/319.3; 428/319.7; 428/317.9

(57) ABSTRACT

The preferred embodiment involves an exercise mat having scented properties. The mat is preferably rectangular in shape and comprised of a flexible material that includes a scented material, such as lavender, embedded within. The scented material can comprise whole leafs, leaf portions, or leaf powder. Alternatively, the scented material can comprise oil or other scented liquid substance. A thin net layer of durable fibers, such as nylon, can be positioned on top of and/or below the mat to increase strength and durability. Alternatively, the exercise mat can comprise an inner layer of scented material surrounded by outer layers of unscented material. In another embodiment, the mat can include a top layer of scented material and a bottom layer of unscented material. The exercise mat can also contain hand grips or support openings for use when performing various activities. The mat can also be magnetized.

### BACKGROUND OF INVENTION

1. Field of the Invention

The invention generally relates to the field of exercise mats. More particularly, the present invention relates to exercise mats, in particular yoga mats and Pilates, having scented properties.

2. Description of the Related Art

Many exercise activities, including aerobic activities, involve positioning oneself on a floor or other flat surface while performing various movements. One such activity, yoga, has been practiced for many centuries. More recently, yoga has become a popular and cost-effective way to help achieve relaxation and relieve stress in the United States. Many yoga practitioners use a yoga mat when practicing yoga. Yoga mats are helpful in that they provide a more sanitary and comfortable practicing surface than a bare floor. However, most yoga mats do nothing more than act as a static surface for exercises to be performed on.

Yoga is often practiced to help relieve stress and allow a person to relax. To help achieve a heightened relaxed atmosphere, some people burn incense or candles to produce a variety of calming scents and fragrances, such as vanilla, ocean scent, or roses. While burning candles can help provide a relaxing aroma, it requires the purchase of candles or incense and can take anywhere up to an hour for the full effect of the aroma to be felt. Further, as yoga mats can often become odorous after repeated use, the burning of candles and incense often has little effect on the scents coming from the yoga mat itself, as candles must be placed a safe distance from the exercise area.

Magnetism has also been used in many inventions to achieve a variety of health-related benefits. Magnetic therapy has a long history dating back to the time of Cleopatra, when the Queen wore a magnet on her face to preserve her youthful appearance. The use of magnets has also been used by NASA to treat astronauts who complained of weakness after returning from space, as well as professional athletes who seek to treat injury. There are many observed actions or effects caused by magnets on biologic processes, including chemical reactions, ion movement, changes in charges and electrical potentials, effects on lipids, starches and proteins, hormones and the large molecules and fundamental cellular processes, among others. However, there is no accepted concept in physics yet of how magnetic fields affect these biologic activities. Many theories have been suggested as to how magnetic therapy works. One theory is that all injuries generate positive magnetic fields and that application of a negative magnetic field relieves pain and speeds healing. Another theory suggests that magnets stimulate red blood cells that have iron. Yet another theory indicates that magnets placed on the body separate positive and negative ions in the blood which physically pushes the walls of blood vessels apart resulting in increased blood flow. Further, magnets also have been theorized to stimulate neurons, blocking signals that cause pains.

Magnetic devices used to treat various health-related conditions have come in various sizes and embodied various shapes. For instance, magnets have been used in items ranging from mattress pads and liners to joint wraps. These inventions however, require that either magnets be placed within the non-magnetic material or magnetic material be attached to the non-magnetic material. These requirements can increase the cost of producing such devices as well as increase the complexity of the manufacturing process.

Therefore, there is a present need for an exercise mat with scented properties, and that can also include magnetic properties, that can be safely and comfortably used to provide a relaxed atmosphere when performing various exercises, including yoga and aerobic activities.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

A primary object of this invention is to provide an exercise mat with scented properties that can be used when performing various exercises, including yoga and aerobic activities.

Another object of this invention is to provide an exercise mat with scented properties and magnetic properties that can be used when performing various exercises, including yoga and aerobic activities.

It is a further object of this invention to provide a mat having hand support means to aid in the performance of various exercises, including yoga.

It is another object of this invention to provide a mat that is comfortable to use while performing various exercises.

It is yet another object of this invention to provide a mat that can help produce a more relaxing atmosphere during the performance of various exercises, including yoga.

It is a still another object of this invention to provide a unique scented mat to the field of exercise mats. An example of a useful scent would be Lavender which most likely earned this name because it was frequently used to help purify the body and spirit.

These objects and further objects and features of the invention will be apparent to one skilled in the art from the disclosure of the present invention as set forth herein.

The preferred embodiment involves an exercise mat having scented properties. The mat is preferably rectangular in shape and comprised of a flexible material that includes a scented material, such as lavender, embedded within. The scented material can comprise whole leafs, leaf portions, or leaf powder. Alternatively, the scented material can comprise essential oil or other scented liquid substance. A thin net layer of durable fibers, such as nylon, can be positioned on top of and/or below the mat to increase strength and durability. Alternatively, the exercise mat can comprise an inner layer of scented material surrounded by outer layers of unscented material. In another embodiment, the mat can include a top layer of scented material and a bottom layer of unscented material. The exercise mat can also contain hand grips or support openings for use when performing various activities. The mat can also be magnetized.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

### BRIEF DESCRIPTION OF THE DRAWINGS.

The accompanying drawings, which are incorporated in and form a part of this specification, illustrate embodiments of the invention and together with the description, serve to explain the principals of this invention.

FIG. 1 is perspective view of the preferred embodiment of the exercise mat with hand grips attached.

FIG. 2 is cross-sectional view of the preferred embodiment of the exercise mat.

FIG. 3 is cross-sectional view of an alternate embodiment of the exercise mat.

FIG. 4 is a cross-sectional view of an alternate embodiment of the exercise mat

FIG. 5 shows an alternative embodiment of the exercise mat containing support openings to help with stability during exercise.

FIG. 6 shows an alternative embodiment of the exercise mat containing hang grips secured to the base with attachment rings.

### DETAILED DESCRIPTION OF THE INVENTION.

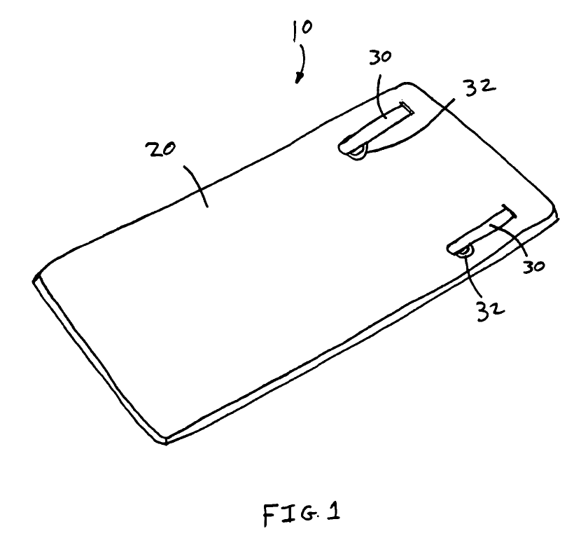

Referring now to the drawings, FIG. 1 shows a perspective view of the preferred embodiment of exercise mat 10. Exercise mat 10 is comprised of a base 20, preferably comprised of a flexible material, such as foam or soft plastic. Base 20 is preferably rectangular in shape, but can vary in shape depending on the type of the exercise to be performed. Dimensions of base 20 are preferably 68 inches by 24 inches, but can vary in size depending on the type of exercise to be performed.

Exercise mat 10 can include hand grips 30 for additional support while performing various exercises. Hand grips 30 are preferably attached within base 20. However, hand grips 30 can also be removably attached to base 20 to enable a user to attach or remove hand grips 30 to perform exercises that either may or may not require hand grips 30. Hand grips 30 each have a handle portion 32, which can be of various shapes and design so long as a user is able to comfortably grip handle portion 32. Hand grips 30 and handle portions 32 can be comprised of nylon, cotton, rubber, or any other material that is flexible and comfortable to grip.

Base 20 can contain scented properties from being infused with scented oil or from the implantation of scented leaves, or scented leaf portions therein. Alternatively, if base 20 is comprised of a molded material, scented leaf powder can be added to the liquid material before the molding process, to provide an evenly distributed scented exercise mat. Base 20 can include a variety of scents, including but not limited to lavender, chamomile, roses, tea tree, mint, jasmine, sage, or any combination thereof.

Base 20 can also contain magnetic properties as a result of having a layer of magnetic material in the pad. Base 20 can be magnetized in various ways as would be recognized by one with ordinary skill in the art. Base 20 preferably has a magnetic flux of between 800 gauss to 2550 gauss, but can contain a magnetic flux in the range of 400 gauss to 3950 gauss. At such levels, base 20 can remain magnetized for approximately 3 years. However, base 20 may remain magnetized for more or less time depending on factors such as environmental conditions, manner of use, and amount of use.

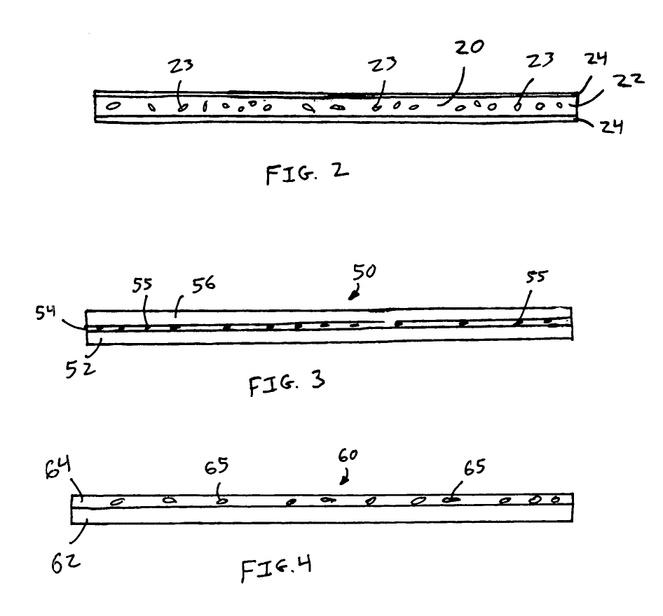

FIG. 2 shows a cross-sectional view of the preferred embodiment of base 20. As depicted, base 20 is substantially comprised of one segment of scented material 22, such as foam. However, base 20 can be comprised of other material that is flexible, durable, and can retain a scent, as would be recognized by one with ordinary skill in the art. Scented material 22 preferably contains a plurality of leaf portions or leaves 23 embedded therein. In another embodiment, scented material 22 can include many scented particles disposed therein as a result of scented powder being introduced into the material during the fabrication of scented material 22. Further, in other embodiments, scented material 22 can include scented oil disposed therein. Base 20 can also contain an outer layer 24, on one or both sides, comprised of a thin polymer fiber coating or nylon fiber coating to help provide structure and increase strength and durability. Outer layer 24 is preferably odor permeable to allow scents to flow from scented material 22 to the user. Further, scented material 22 can also be magnetized to provide a scented mat with magnetic properties.

FIG. 3 shows a cross-sectional view of an alternative embodiment of exercise mat 50. Mat 50 is comprised of a bottom portion 52, middle portion 54, and top portion 56. Bottom portion 52 is comprised of a flexible and substantially impermeable material, such as rubber, to prevent the accumulation of moisture or oil on the floor and provide traction. Middle portion 54 is preferably comprised of scented flexible polyvinyl chloride foam material, but can be comprised of other durable and flexible material that is capable of retaining a scent. Middle portion 54 preferably contains a plurality of scented leaves or leaf portions 55 embedded therein. Middle portion 54 can also contain a magnetic sheet that is magnetized to provide a mat 50 with magnetic properties. Top portion 56 is comprised of a flexible and semi-permeable (partially absorbent) material. In this embodiment, top portion 56 can absorb moisture from a user to provide for a drier and more comfortable exercise surface. Further, top portion 56, because of its semi-impermeability, can be infused with scented oil or implanted with leaf extract to provide a scented exercise surface. Exercise mat 50 can further comprise a thin layer of polymer fiber laminate coating matrix (not shown) or nylon coating matrix positioned on or within the distal surface of top portion 56 for providing structure and increasing strength and durability, while not hindering the partially absorbent qualities of top portion 56.

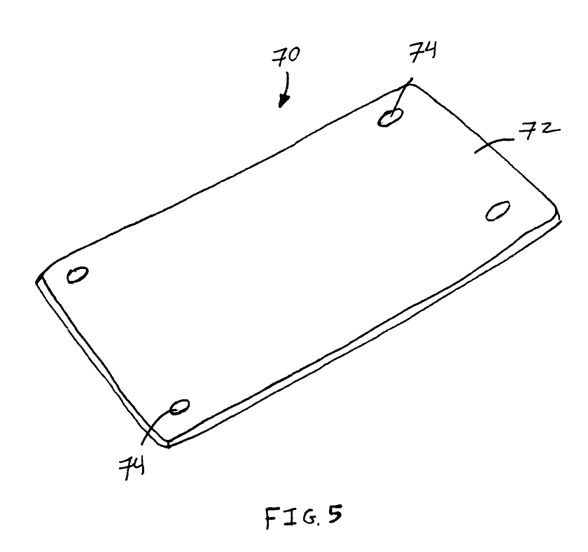

FIG. 4 shows a cross-sectional view of an alternative embodiment of exercise mat 60. Mat 60 is comprised of a bottom portion 62 and a top portion 64. Bottom portion 62 is comprised of a flexible and substantially impermeable material, such as rubber, to prevent the accumulation of moisture or oil on the floor and provide traction. Top portion 64 is preferably comprised of flexible and scented material that is semi-permeable (partially absorbent). In this embodiment, top portion 64 can absorb moisture from a user to provide for a drier and more comfortable exercise surface. Further, top portion 64, because of its semi-impermeability, can be infused with scented oil or implanted with leaf extract to provide a scented exercise surface. Top portion 64 preferably contains a plurality of leaf portions or leaves 65 embedded therein. In another embodiment, top portion 64 can include many scented particles disposed therein as a result of scented powder being introduced into the material during the fabrication of top portion 64. Further, in other embodiments, top portion 64 can include scented oil disposed therein. Still further, top portion 64 can be magnetized to provide an exercise mat 60 with magnetic properties. Exercise mat 60 can further comprise a thin layer of polymer fiber laminate coating matrix (not shown) or nylon coating matrix positioned on or within the distal surface of bottom portion 62 and/or top portion 64 for providing structure and to increase strength and durability, while not hindering the partially absorbent qualities of top portion 64.

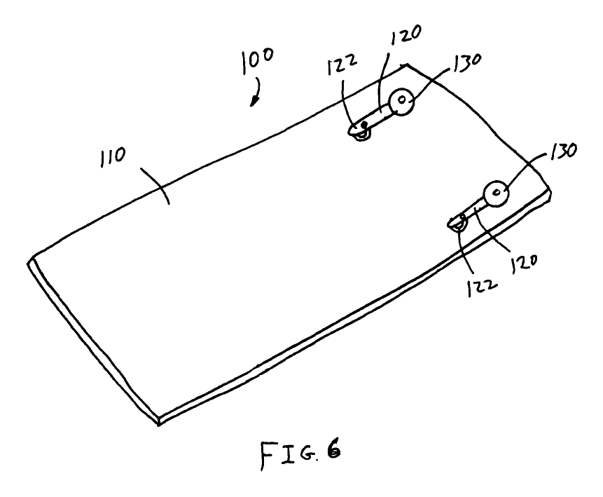

FIG. 5 shows a perspective view of an alternate embodiment exercise mat 70. Exercise mat 70 contains a base 72. Base 72 includes support openings 74. Support openings 74 provide support for arms or legs during performance of certain exercises, particularly yoga poses and stretches. Support openings 74 are preferably round or oval in shape. However, support openings 74 can also be slits that expand or contract depending on whether or not an appendage is positioned therethrough. Base 72 preferably includes four support openings 74. However, base 72 can include two or more support openings 74. Support openings 74 are preferably positioned at each corner of base 72. However, support openings 74 can also be placed along the peripheral portion of base 72 to provide support means at various locations throughout base 72. Support openings 74 can be various sizes to accommodate either hands or feet. Further, one end of base 72 can contain smaller support openings 74 to accommodate hands, while the other end of base 72 can contain larger support openings 74 to accommodate feet. FIG. 6 shows another alternative embodiment of the exercise mat 100. Exercise mat 100 contains a base 110 having at least two hand grips 120. Hand grips 120 each have a handle portion 122 and are attached to exercise mat 100 by attachment rings 130. Handle portion 122 can be of various shapes and design so long as a user is able to comfortably grip handle portion 122. Hand grips 120 and handle portions 122 can be comprised of nylon, cotton, rubber, or any other material that is flexible and comfortable to grip. Attachment rings 130 can be incorporated into hand grips 120 or can be formed as a part of base 110. If attachment rings 130 are formed as a part of base 110, hand grips 120 would be removably attachable to attachment rings 130.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description, together with the objects of the invention and the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Off ice and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

I claim:

1. An exercise mat comprising:
a) a scented layer of material; and
b) a non-scented layer of material positioned on at least one side of the scented layer of material
whereby the exercise mat releases scented aromas while a user engages the exercise mat while performing various exercise activities, including yoga.

2. The exercise mat of claim 1, wherein the scented layer of material is comprised of a layer of material having scented oil disposed therein.

3. The exercise mat of claim 1, wherein the scented layer of material is comprised of a layer of material having a plurality of scented leaf portions embedded therein.

4. The exercise mat of claim 1, wherein the scented layer of material is comprised of a layer of material having a plurality of scented leaves embedded therein.

5. The exercise mat of claim 1, wherein the non-scented layer of material is positioned on each side of the scented layer of material.

6. The exercise mat of claim 1, further comprising at least one handgrip coupled to the scented layer of material.

7. The exercise mat of claim 1, further comprising at least one opening in the scented layer and the non-scented layer for the purpose of providing support to a user during various exercise activities.

8. The exercise mat of claim 1, wherein the scented layer is magnetized.

9. An exercise mat comprising:
a) a substantially hydrophobic layer of material;
b) a scented layer of material positioned on top of the substantially hydrophobic layer of material; and
c) a partially absorbent layer of material positioned on top of the scented layer of material
whereby the exercise mat releases scented aromas while a user engages the exercise mat while performing various exercise activities, including yoga, and the non-hydrophobic layer of material absorbs moisture to provide a drier and more comfortable exercise surface.

10. The exercise mat of claim 9, wherein the scented layer of material is polyvinyl chloride foam.

11. The exercise mat of claim 9, wherein the substantially hydrophobic layer of material is a rubber composite.

12. The exercise mat of claim 9 further comprising a polymer fiber laminate on the top and bottom thereof for the purpose of increasing strength and durability.

13. The exercise mat of claim 9 further comprising a polymer fiber laminate coating matrix positioned on the distal surface of the partially absorbent layer of material for the purpose of increasing strength and durability.

14. The exercise mat of claim 9 further comprising at least hand grip attached to the partially absorbent layer for the purpose of providing support to a user during exercise.

15. The exercise mat of claim 9, wherein the scented layer of material is magnetized.

16. An exercise mat comprising:
a) a scented layer of material;
b) a non-scented layer of material positioned on at least one side of the scented layer of material; and
c) means for supporting a user coupled to the scented layer of material
whereby the exercise mat releases scented aromas while a user engages the exercise mat while performing various exercise activities, including yoga.

17. The exercise mat of claim 16, wherein the means for supporting a user is at least one hand grip.

18. The exercise mat of claim 16, wherein the means for supporting a user is at least one opening in the scented layer and the non-scented layer for the purpose of providing support to a user during various exercise activities.

19. The exercise mat of claim 16, wherein the scented layer of material is magnetized.

20. The exercise mat of claim 16 further comprising a polymer fiber laminate on the top and bottom thereof for the purpose of increasing strength and durability.
